(19) United States
(12) Patent Application Publication
(10) Pub. No.: US 2015/0132503 A1
(43) Pub. Date: May 14, 2015

(54) METHODS OF FORMING NEAR FIELD TRANSDUCERS

(71) Applicant: SEAGATE TECHNOLOGY LLC, Cupertino, CA (US)

(72) Inventors: Michael C. Kautzky, Eagan, MN (US); Tong Zhao, Eden Prairie, MN (US); Sethuraman Jayashankar, Excelsior, MN (US); Hui Brickner, Savage, MN (US)

(21) Appl. No.: 14/540,361

(22) Filed: Nov. 13, 2014

Related U.S. Application Data
(60) Provisional application No. 61/903,467, filed on Nov. 13, 2013.

(51) Int. Cl. G11B 7/22

(52) U.S. Cl. CPC G11B 7/22
USPC 427/554

(57) ABSTRACT

Methods of forming a near field transducer (NFT), the method including depositing a plasmonic material; and laser annealing the plasmonic material.

### CROSS REFERENCE TO RELATED APPLICATION

This application claims priority to U.S. Provisional Applications No. 61/903,467 entitled METHODS OF FORMING NEAR FIELD TRANSDUCERS, filed on Nov. 13, 2013, the disclosure of which is incorporated herein by reference thereto.

### SUMMARY

Disclosed herein is a method of forming a near field transducer (NFT), the method including depositing a plasmonic material; and laser annealing the plasmonic material.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIG. 1A presents flow diagrams for various disclosed methods.

FIG. 1B displays other embodiments of disclosed methods.

FIG. 2 shows a graph of the calculated transmittance versus the wavelength of the laser energy in nanometers (nm) for gold (an exemplary plasmonic material) for gold film thicknesses of 25 nm, 50 nm, and 100 nm.

FIG. 3 shows a graph of grain size versus the anneal wavelength.

FIGS. 4A and 4B depict a scanning electron microscope (SEM) image of gold (Au) laser annealed at 530 nm for 80 ns with a fluence of 190 mJ/cm² (FIG. 4A) and 140 mJ/cm² (FIG. 4B).

FIG. 5A depicts an exemplary device that includes a blocking layer.

FIG. 5B shows calculations of reflectance and transmittance versus the wavelength of laser energy for a 25 nm and a 60 nm thick exemplar copper blocking layer.

FIG. 6A shows another embodiment of a device including a blocking layer.

FIG. 6B shows the calculated efficiency gains (better absorption) obtained as a result of oblique incidence illumination of the annealing laser radiation.

FIG. 6C shows the calculated efficiency gains (better absorption) obtained as a result of oblique incidence illumination of the annealing laser radiation in the case where the plasmonic material (e.g., the gold peg in this particular example) has been encapsulated on top by a layer of a dielectric.

FIG. 7 illustrates exemplary methods that include use of a blocking layer.

FIG. 8 shows a graph of the fraction of NFT discs that will contain a single grain as a function of the disc diameter for various grain sizes.

FIG. 9 shows a graph of the fraction of NFT pegs that sill contain a single grain as a function of the peg length for various grain sizes.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range. As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

“Include,” “including,” or like terms means encompassing but not limited to, that is, including and not exclusive.

Disclosed herein are methods of forming at least a portion of a near field transducers (NFTs) that utilize laser annealing. Disclosed methods can advantageously form portions of NFTs, for example a peg in a peg/disc type of NFT, that include less grains of plasmonic material and in some embodiments a peg that includes a single grain of plasmonic material. Single grains of plasmonic materials in a peg can be advantageous for a number of reasons. First, single grain pegs will be less susceptible to grain growth and densification when exposed to high temperatures. Second, single grain pegs may provide enhancements in the strength of the peg material. Third, single grain pegs may provide improved thermal conductivity which ultimately leads to greater temperature reductions. Fourth, single grain pegs may provide an improved electron scattering rate and longer surface plasmon polaritron (SPP) propagation length. Laser annealing can also advantageously be used to improve the density of the NFT material.

Likely dimensions of a NFT can indicate an average grain size that could be utilized to create a “single grain” peg. In some embodiments where a peg (that is part of a disc and peg NFT) has a 20 to 40 nanometer (nm) width, a 20 nm air bearing surface (ABS) to disc length, and a 145 nm total peg length, calculations based on a two dimensional array of square grains would indicate that, although grain boundaries can't statistically be eliminated, an average grain size of at least 400 nm to 500 nm should minimize grain boundaries in the peg. In some embodiments where the peg has a total length of 60 nm (as opposed to 145 nm in the example above), an average grain size of at least 300 nm should minimize, but can't statistically be eliminated, grain boundaries in the peg.

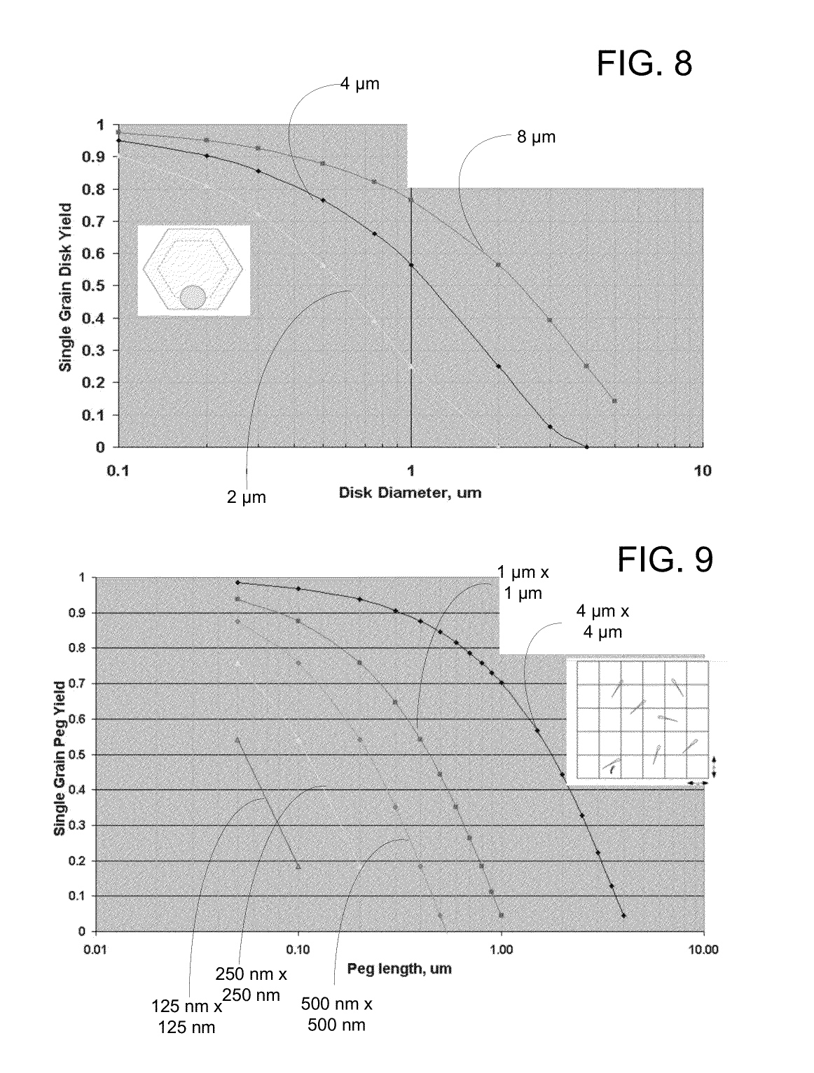

Another way of considering grain size with respect to the size of various portions of an illustrative NFT can be seen in FIGS. 8 and 9. The NFT transducer element, in its simplest form, consists of a nominally 250 nm diameter gold disk, connected to a gold peg that varies in length nominally from 15 nm to 100 nm. FIG. 8 shows the fraction of NFT discs that will only contain a single grain of Au as a function of Disk diameter, for grain sizes of 2, 4, and 8 um. For a 250 nm disk, it is seen that a 4 um hexagonal grain yields between 85 to 90% single grain disks. With a larger grain size of 8 um, the yield of a 250 nm disk increases to slightly over 90%. FIG. 9 shows the fraction of the NFT pegs that will only contain a single grain of Au as a function of peg length, for grain sizes from 125 nm×125 nm to 4 μm×4 μm. As seen in FIG. 9, for a 50 nm peg, it is seen that a 4 μm×4 μm grain yields between 95 to 97% single grain pegs. With a larger peg length of 100 nm, the yield of single grain pegs is still about 90%. Grain sizes of below 0.5 μm (500 nm) show a significant drop in the yield of single grain pegs.

Methods disclosed herein utilize laser annealing to provide localized surface heating to induce grain growth of the material of the NFT (e.g., plasmonic material). Disclosed methods generally include a step of depositing a plasmonic material and laser annealing the plasmonic material. The laser anneal can occur at different stages of manufacture. For example, the laser annealing can occur before any structural processing has been done to the plasmonic material or after one or more structural processing steps. In some embodiments, a film or a sheet film of a plasmonic material (at the wafer level of processing) can be laser annealed and then that grain reduced plasmonic material can be patterned into a peg. In some embodiments, plasmonic material that has already been patterned into a peg (at the wafer level of processing) can be laser annealed and then that grain reduced plasmonic material can be further processed into a NFT. A grain reduced plasmonic material can refer to a material, film, or device element where the number of grains of plasmonic material in a unit area or volume of the material, film, or device element (such as a NFT peg for example) has been or is reduced through an increase in the average size of the grains of the material, film, or device element. In some embodiments, plasmonic material that has already been patterned into a peg and further processed into a NFT, for example an encapsulated peg (at the wafer level of processing) can be laser annealed to form a grain reduced NFT.

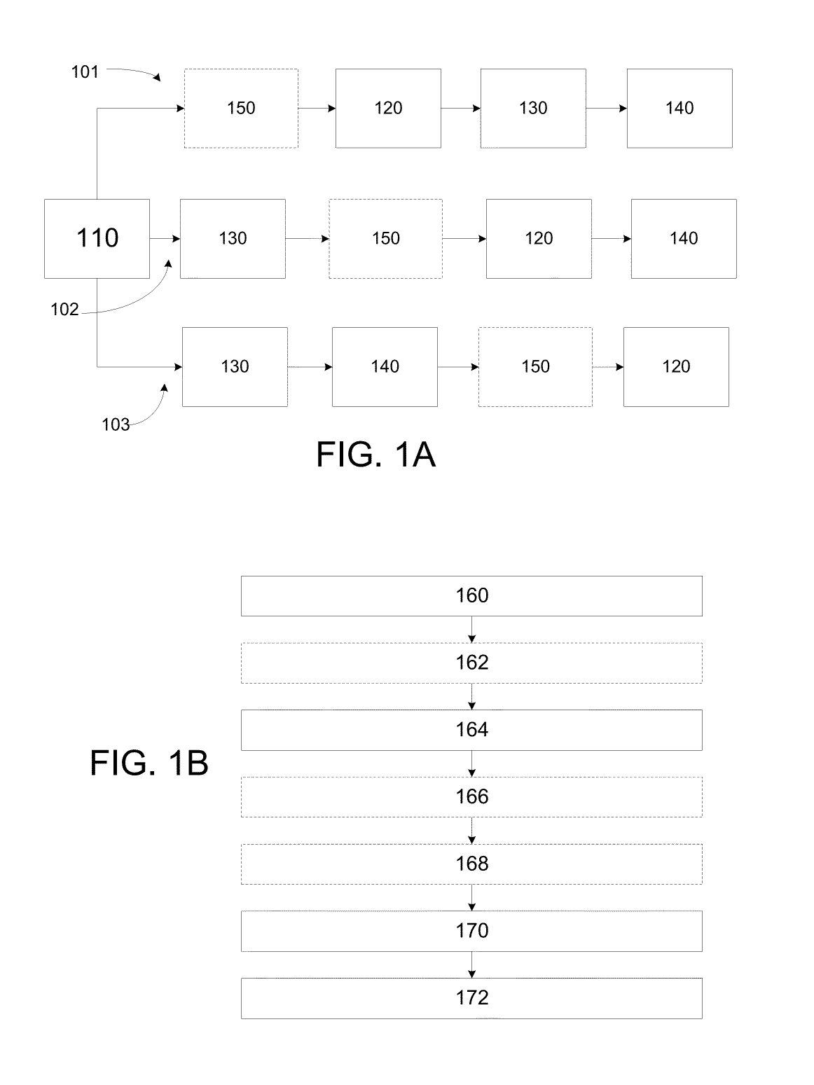

FIG. 1A presents flow diagrams for various disclosed methods. All of the methods disclosed therein begin with step 110, depositing plasmonic material. The step of depositing the plasmonic material can utilize known methods of materials deposition including physical vapor deposition (PVD), chemical vapor deposition (CVD), metallorganic chemical vapor deposition (MOCVD), and electrodeposition for example. The plasmonic material can be any material that has plasmonic properties and is desired to be a NFT within the device. Exemplary plasmonic materials can include, for example gold (Au), silver (Ag), aluminum (Al), copper (Cu), and alloys thereof.

In some embodiments, Au can be co-sputtered with one of the following elements: Cu, Rh, Ru, V or Zr, or an Au alloy can be deposited directly from an alloy target, on Si substrates at room temperature. The doping level varies between 0.5% and 30% and the film thickness varies between 150 nm and 300 nm. The Au alloy may include Au and at least one of: Cu, Rh, Ru, Ag, Ta, Cr, Al, Zr, V, Pd, Ir, Co, W, Ti, Mg, Fe and Mo. In some embodiments, gold can be doped with other materials. For example, in some embodiments, nano-sized (e.g., 1-5 nm) oxide particles can be doped into Au films to enhance its mechanical property through oxide dispersion hardening. A dispersion of insoluble particles can harden a material because dislocation migration cannot pass the particles. Dispersion hardening from extremely stable particles, e.g. oxide or nitride particles, is the least sensitive to elevated temperatures compared to other hardening mechanisms. The nitride particles can include for example, Ta, Al, Ti, Si, In, Fe, Zr, Cu, W or B Nitride. In some embodiments, Au can be reactively sputtered with V or Zr to form V₂O₅ or ZrO₂ nanoparticles embedded in an Au matrix. The deposition can be done through either reactive co-sputtering from multiple metal targets or reactive sputtering from an alloy target. In other embodiments, the oxide dopant can comprise an oxide of at least one of: Mg, Ca, Al, Ti, Si, Ce, Y, Ta, W or Th. Examples of such oxides include: MgO, CaO, Al₂O₃, TiO₂, SiO₂, CeO₂, Y₂O₃, Ta₂O₅, WO₂ or ThO₂. When selecting an oxide, one might consider the energy needed to de-bond a material; and/or the solubility between the metal element in such particle with Au.

In some embodiments, disclosed NFTs may include silver and at least one other element or compound. The at least one other element or compound can exist within an alloy of the silver, or can be within the silver but not in the form of an alloy, for example as a nanoparticle. In some embodiments, disclosed NFTs may include a silver (Ag) alloy. The use of silver alloys can be advantageous because pure silver has better optical properties than other plasmonic materials, for example gold (Au). This could allow for more aggressive methods of material engineering without obtaining a material with useless optical properties. Silver also has the advantage, with respect to gold, of costing less.

Useful silver alloys may include one or more than one (at least one) secondary element. Exemplary secondary elements can include, for example copper (Cu), palladium (Pd), gold (Au), zirconium (Zr), platinum (Pt), geranium (Ge), nickel (Ni), tungsten (W), cobalt (Co), rhodium (Rh), ruthenium (Ru), tantalum (Ta), chromium (Cr), aluminum (Al), vanadium (V), iridium (Ir), titanium (Ti), magnesium (Mg), iron (Fe), molybdenum (Mo), silicon (Si), or combinations thereof. In some embodiments, a NFT can include a silver alloy that includes copper, palladium, or combinations thereof. In some embodiments, a NFT can include a silver alloy that includes palladium. In some embodiments a NFT can include a silver alloy that includes both palladium and copper. In some embodiments, secondary elements such as copper, zirconium, zirconium oxide, platinum, aluminum, or gold may improve the corrosion resistance of Ag. Such alloys could have better environmental stability which can in turn improve the reliability of the NFT against possible acidic environments, which can be formed by decomposition of lubricants on the magnetic medium disk surface. Such secondary elements (those that improve corrosion resistance) can either be used as a second element in the alloy, or a third element in the alloy.

In some embodiments, a NFT can include silver that includes nanoparticles of a secondary element (or compound) instead of an alloy of silver with a secondary element. Exemplary materials that can be utilized in such embodiments can include for example oxides of V, Zr, Mg, calcium (Ca), Al, Ti, Si, cesium (Ce), yttrium (Y), Ta, W or thorium (Th), Co, or combinations thereof. Further exemplary materials that can be utilized in such embodiments can include for example nitrides of Ta, Al, Ti, Si, indium (In), Fe, Zr, Cu, W, boron (B), halfnium (Hf), or combinations thereof. In some embodiments, nanoparticles can be 5 nanometers (nm) or less in diameter. In some embodiments, the nanoparticles can be included at a level that is not greater than 5 atomic percent (at %) of the silver. A nanoparticle containing silver material can be fabricated using known methods, including for example reactive sputtering. For example, an Au film with oxide or nitride particles can be fabricating using either reactive co-sputtering in O₂ or N₂ from multiple targets of single elements or from reactive sputtering in O₂ or N₂ from a single target with the desired metal element mixing ratio.

Alloys useful in disclosed NFTs can be described by, for example, the atomic percent (at %) of the at least one secondary element. In some embodiments, a useful alloy can have from 3 at % to 30 at % of the at least one secondary element. In some embodiments, a useful alloy can have from 5 at % to 25 at % of the at least one secondary element. In some embodiments, a useful alloy can have from 5 at % to 15 at % of the at least one secondary element.

In some embodiments, the plasmonic material can include an electrically conductive nitride material. Exemplary electrically conductive nitride materials can include, for example, ZrN, TiN, TaN, HfN, or combinations thereof. In some embodiments NFTs can include ZrN, TiN, or combinations thereof.

All of the methods include a step 120 of laser annealing. Generally, laser annealing refers to the use of a laser to expose a material to radiation to heat the material. In the context of disclosed methods, laser annealing refers to the use of a laser to expose the deposited plasmonic material to radiation in order to heat the material to induce grain growth. In some embodiments, the laser anneal step can be carried out using a wavelength in the UV to mid-visible range. Such wavelengths can increase the amount of absorption by the plasmonic material (e.g., gold) and decrease the reflection of the laser energy. In some embodiments, the laser anneal step can be carried out using a laser producing energy having a wavelength of not greater than 550 nm, and in some embodiments a wavelength of not greater than 530 nm.

All of the methods also include a step 130 of forming a peg. Generally, the peg can be formed from a film or layer of plasmonic material using various processing methods. In some embodiments, formation of the peg can be accomplished using one or more patterning processes, one or more milling processes, or some combination thereof. In some embodiments, forming the peg can be accomplished using patterning and milling for example.

All of the methods also include a step 140 of forming a NFT. Generally, the NFT is formed from the peg (e.g., step 140 is accomplished after step 130). Generally, the NFT can be formed using various processes, including for example subtractive processes and patterning processes for example. Generally, the formation of a NFT can include deposition of a plasmonic material and one or more structural processing steps. Structural processing steps can include, for example milling at least a portion of the plasmonic material into a precursor of a NFT, and further material removal (e.g., polishing such as chemical mechanical polishing (CMP) for example), or combinations thereof.

In some exemplary embodiments of disclosed methods, optional steps can also be carried out. This optional step includes forming an antireflective coating over the plasmonic material. The optional step 150 in FIG. 1A includes forming or depositing an antireflective coating. The antireflective coating can be formed at various points in various methods. If an antireflective coating is to be formed, it can generally be deposited before the laser anneal step is to occur. As seen in method 101, an antireflective coating can optionally be deposited first, as seen at step 150 before or, in some embodiments immediately before the laser anneal step 120. Method 102 can also include an optional step of forming an antireflective coating, 150 but it occurs after the step of forming the peg, 130. Method 103 can also include an optional step of forming an antireflective coating, 150 but it occurs after the step of forming the NFT, 140.

In some embodiments, the antireflective coating can include materials that generally do not interact with the NFT film being annealed. If a material that does interact is utilized for the antireflective coating, such an interaction may be able to be utilized as part of the NFT formation structure or it can be removed prior to formation of the NFT element. In some embodiments, materials with a finite absorption index (k) can be utilized. Exemplary materials can include, for example amorphous carbon, diamond, diamond like carbon (DLC), metal silicides, oxides, oxynitrides, and metals. In some embodiments, an antireflective coating can have a thickness that is sufficient to absorb the energy of the laser radiation and transmit it to the NFT elements in proximity to it. For example, an antireflective coating can be as thin as 5 nm, and in some embodiments as thin as 10 nm. In some embodiments, an antireflective coating can have a thickness as thick as 1000 μm, and in some embodiments as thick as 300 nm.

Additional optional steps can also be utilized in disclosed methods. In some exemplary methods, additional annealing steps (either with or without the use of a laser), additional patterning steps, additional etching steps, or any combinations thereof can be carried out. In an exemplary method, a plasmonic material can be deposited, the plasmonic material can be laser annealed (at the wafer level), the plasmonic material can be thermally annealed (via an oven anneal, for example) at some temperature for some time, the material can then be cleaned, the plasmonic material can then be milled to a desired thickness, and then the peg can be formed. A more specific example of such an exemplary method could include, for example, depositing a plasmonic material (for example at least 100 nm), laser annealing the plasmonic material, oven annealing the plasmonic material at 225° C. for 3 hours, cleaning the material with a snow clean (CO₂ cleaning), milling the cleaned plasmonic material down to a film of 25 nm, and then patterning the film into a peg having the desired dimensions.

In some embodiments where the laser annealing step is conducted at the sheet film stage, it may be followed, preceded by, or both, an additional laser anneal step (or steps). Additionally, in some embodiments, furnace anneal steps may also be included in such methods. Furthermore, before a peg is formed, the existing film of plasmonic material may be cleaned to remove particulates thereon. Furthermore, the thickness of the plasmonic material may be reduced to a more desirable thickness either prior to or after peg formation using various methods, including, for example milling, chemical mechanical polishing (CMP), etching (either wet or dry), or any combination thereof.

FIG. 1B displays another embodiment of a disclosed method. The method includes a first step 160, depositing a plasmonic material. The methods and materials can be such as were discussed above. In some embodiments, an optional step, step 162, a furnace anneal can be undertaken next. The optional furnace anneal, step 162, can be carried out using a furnace or an oven and can utilize temperatures from 50° C. up to close to the melting point of the NFT material (for example about 1050° C. for Au-based NFT. In some embodiments, the optional furnace anneal step can utilize temperatures from 50° C. to 500° C. After the optional furnace anneal step 162 (or after deposition of the plasmonic material step 160 if the optional furnace anneal step is not undertaken) step 164, a laser anneal step can be undertaken. The laser anneal step 164 can include steps and details such as those discussed above.

Another optional step can be undertaken next, step 166, another laser anneal. The additional laser anneal step, which can also be referred to as a secondary laser anneal step, can include steps and details such as those discussed above. Another optional step is step 168, another furnace anneal. It should be noted that either or both of the optional steps 166 and 168 can be undertaken. The additional furnace anneal step, which can also be referred to as a secondary furnace anneal step, can include steps and details such as those discussed above.

Such methods can also include step 170, an additional processing step. The additional processing step 170 can include cleaning methods, subtractive methods, patterning methods, or some combination thereof. For example, a processing step 170 can include a cleaning process or processes (e.g., snow cleaning), a milling process or processes, an etching process or processes, chemical mechanical processing (CMP), or any combination thereof. In some embodiments, the additional processing step can function to clean the annealed plasmonic material and decrease the thickness thereof, for example. Such methods can also include step 172, forming the peg. Forming the peg can be accomplished using various methods, such as those discussed above for example.

It should also be noted that laser annealing steps can be utilized at other intermediary steps in the formation of a NFT, after formation of the peg. For example, laser annealing can be utilized during formation of a disc of the NFT, a heat sink of the NFT, or both. Such embodiments of disclosed methods can afford NFTs in which various elements (peg, disc, heat sink, or some combination) are advantageously made of grain reduced plasmonic material. Laser annealing can also be carried out after the patterned NFT device is partially or completely covered by an encapsulant metal or dielectric layer.

In some embodiments, laser annealing the plasmonic material (at any stage) without further considerations or processes can have a detrimental effect on structures or materials at other regions of the wafer, for example located beneath the plasmonic material. In some embodiments, particular characteristics of the laser anneal can be further characterized or specified in order to avoid detrimental effects, to proffer advantageous results, or some combination thereof. In some embodiments, particular characteristics of the material to be laser annealed can be further characterized or specified in order to avoid detrimental effects, to proffer advantageous results, or some combination thereof.

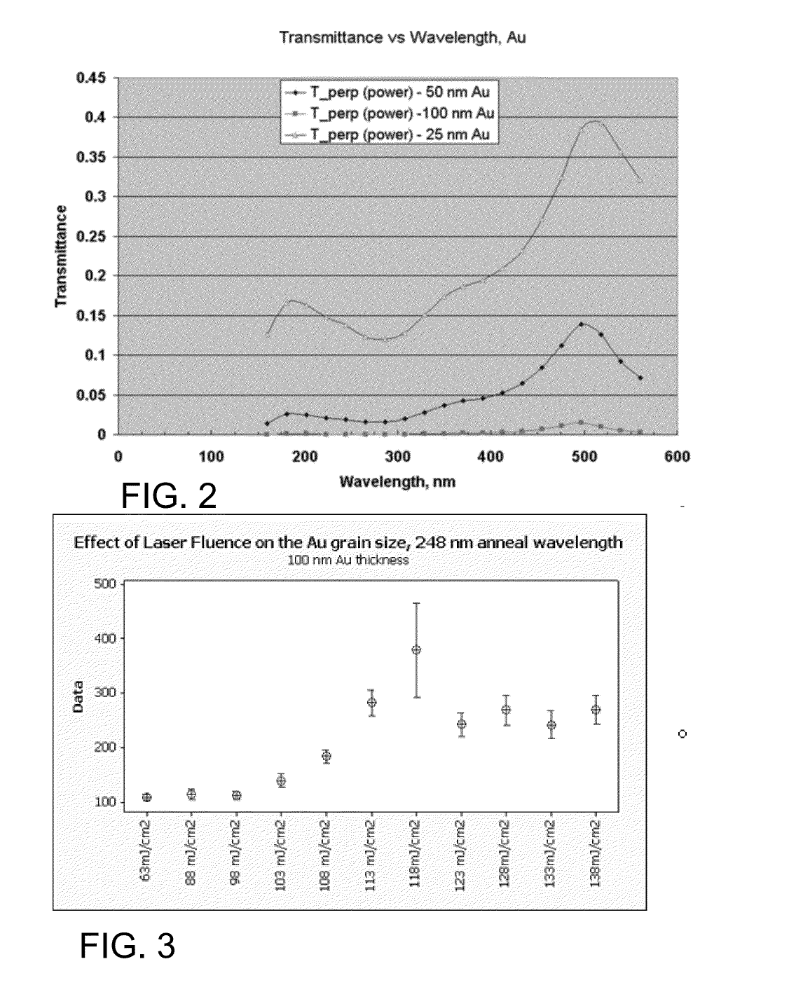

FIG. 2 shows a graph of the calculated transmittance versus the wavelength of the laser energy in nanometers (nm) for gold (an exemplary plasmonic material) for gold film thicknesses of 25 nm, 50 nm, and 100 nm. As seen there, a 25 nm gold film transmits nearly 35% of the incident radiation to the underlying structures. Also as seen there, a reduction in the transmitted 530 nm radiation through the gold (to a value under 5%) can be obtained if the topmost gold film layer exposed to the laser radiation is increased to 100 nm. Furthermore, reduction in the wavelength of the laser also decreases the transmittance of the gold film thereby minimizing or preventing thermal damage to the underlying materials and structures.

In some embodiments, the plasmonic material to be laser annealed can have a thickness of at least about 50 nm. In some embodiments, the plasmonic material to be laser annealed can have a thickness of at least about 100 nm. In some embodiments where gold is the plasmonic material to be laser annealed, the gold can have a thickness of at least about 50 nm. In some embodiments where gold is the plasmonic material to be laser annealed, the gold can have a thickness of at least about 100 nm. In some embodiments, the film can also be etched or planarized after laser annealing to obtain a desired thickness of the plasmonic material.

In some embodiments, the wavelength of the energy of the laser utilized in the laser annealing step can have a wavelength of not greater than 600 nm. In some embodiments, the wavelength of the energy of the laser utilized in the laser annealing step can have a wavelength of not greater than 550 nm. In some embodiments, the wavelength of the energy of the laser utilized in the laser annealing step can have a wavelength of not greater than 500 nm. In some embodiments, the wavelength of the energy of the laser utilized in the laser annealing step can have a wavelength of 530 nm.

Based on the graph of FIG. 2, it may seem that wavelengths even lower than 500 nm may be useful. FIG. 3 shows that annealing a 100 nm Au film at a lower wavelength (for example, 248 nm in this particular example) also results in grain size increases. As seen in FIG. 3, a laser anneal with a fluence of 118 mJ/cm² obtains the highest mean grain size. In fact, the maximum grain size obtained at a 248 nm anneal is larger, possibly due to the higher efficiency at the lower wavelength. This may be due to the lower wavelength having a smaller absorption depth, and hence being more efficient.

In some embodiments, the wavelength chosen for the laser anneal can be as low as 140 nm, for example. In some embodiments, the wavelength chosen for the laser anneal can be as high as 3.0 micrometers (μm). In some embodiments, the pulse duration of the laser anneal can have a minimum of 10 femtoseconds (fs). In some embodiments, the laser anneal can have a continuous pulse (infinite time duration). In some embodiments, the laser anneal can be accomplished with a minimum of 1 pulse. In some embodiments, the laser anneal can be accomplished with a maximum of 1000 pulses, for example. In some embodiments, the pulse power/energy can be constant from pulse to pulse. In some embodiments, the pulse power/energy can vary from pulse to pulse. In some embodiments, the laser pulses can be in the form of exposure fields of varying areas, such as those corresponding to a cube exposure field of a wafer, for example. Alternatively, the pulses can be concentrated spots, the dimension of which could range from as low as 0.5 μm, or as high as several tens of mm. The laser pulses could also be in the form of linear rectangular slices which are scanned across the wafer, for example. The atmosphere of the annealing could be ambient air, or it could include various reactant or non-reactant gases or liquids. The annealing could also be done under vacuum.

The laser beam itself can be normal to the surface of the wafer or work surface, or it could be at an oblique angle. Various metrology tools such as reflectometers and pyrometers may be used to control the laser annealing process. The laser beam can be tightly focused on the surface, or it could be diffuse. The laser beam hitting the surface could also form an image of a mask template on the wafer through a projection lens system. The wafer or work piece can be heated or cooled during the laser anneal.

The time that the plasmonic material is subjected to the laser annealing can also affect the characteristics of a NFT formed thereby. In some embodiments, plasmonic material can be laser annealed for at least 1 femtosecond of exposure time or at least 10 picoseconds of exposure time. In some embodiments, plasmonic material can be laser annealed for at least 30 nanoseconds of exposure time or at least 300 nanoseconds of exposure time. In some embodiments, plasmonic material can be laser annealed for not greater than 300 milliseconds of exposure time or not greater than 1000 milliseconds of exposure time. In some embodiments, plasmonic material can be laser annealed for not greater than 500 milliseconds of exposure time.

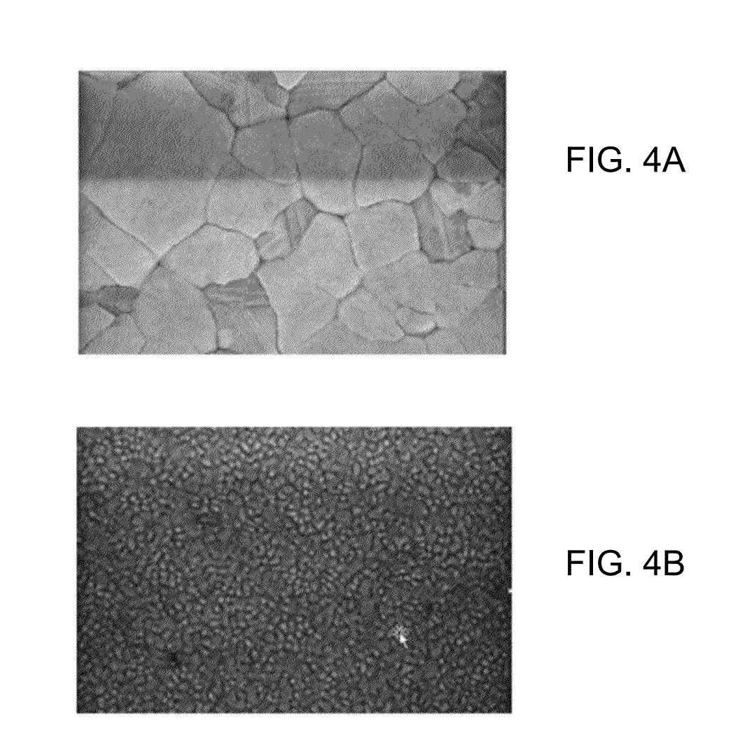

The level of laser annealing could also be described by the fluence of the laser. FIGS. 4A and 4B depict a scanning electron microscope (SEM) image of gold (Au) laser annealed at 530 nm for 80 ns with a fluence of 190 mJ/cm² (FIG. 4A) and 140 mJ/cm² (FIG. 4B). As seen from a comparison of these two images, a higher fluence of laser energy results in larger grain sizes. In some embodiments, plasmonic material can be laser annealed with a fluence of between 10 to 20 milliJoules per square centimeter (mJ/cm²). In some embodiments, plasmonic material can be laser annealed with a fluence between 60 to 400 mJ/cm². In some embodiments, plasmonic material can be laser annealed with a fluence of up to 1500 mJ/cm². In some embodiments, plasmonic material can be laser annealed with a fluence of 200 mJ/cm².

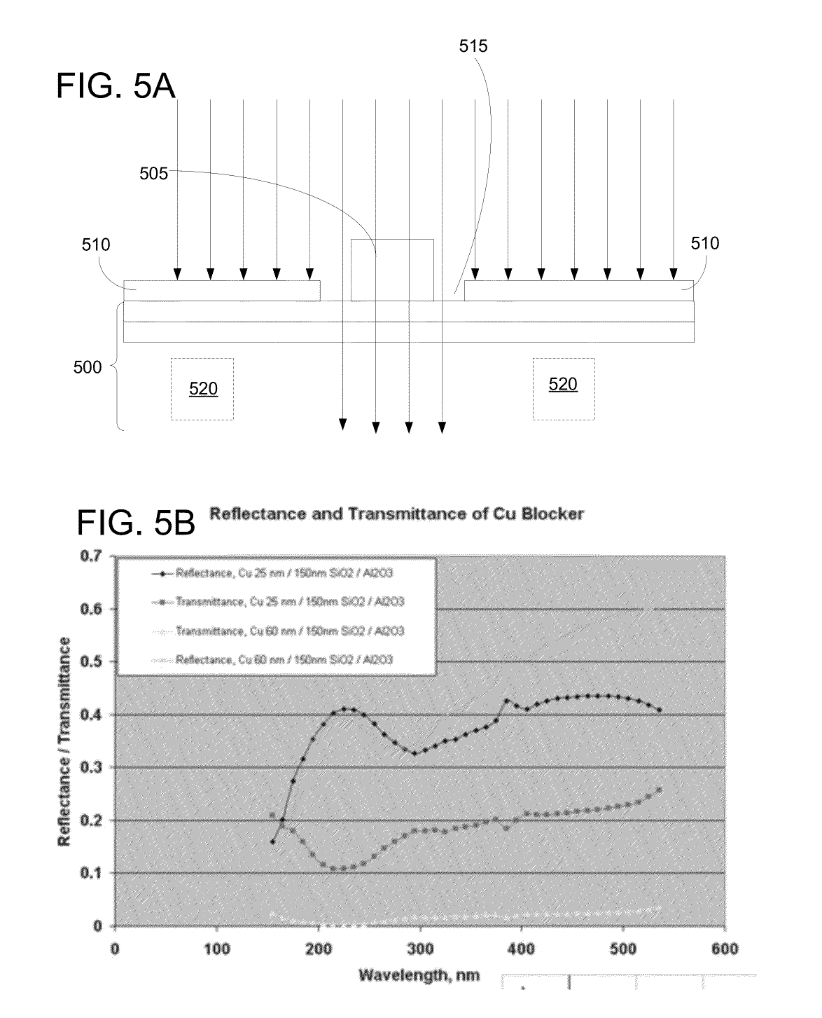

Another optional step that can be carried out includes the use of a blocking layer. The blocking layer, which can also be referred to as a sacrificial blocking layer, can be made of a laser absorbing material with a high thermal mass. Such a blocking layer can be disposed on the top of the wafer surface to block the direct laser radiation from reaching the sensitive underlying structures already formed in or on the device. The thickness of the blocking layer can be sufficient enough to absorb all the laser energy that impinges upon it. The optional blocking layer can be formed over some portion of the underlying structure upon which the plasmonic material is deposited. The blocking layer can generally include at least one fenestra. FIG. 5A depicts a device at some state of preparation that includes a blocking layer 510 formed over an underlying structure 500. The blocking layer 510 includes at least one fenestra 515. The fenestra 515 is located so that the plasmonic material 505, which may be a peg, a further processed peg, or simply a deposited layer at this point, is contained within the fenestra 515. The holes or fenestrae can be advantageously placed or formed on the blocking layer in order to expose only the areas of the device that need to be annealed by direct laser radiation.

The blocking layer can generally be made of any material that can at least diminish the amount of laser energy or heat for example, that is transmitted there through. In some embodiments, the blocking layer may be made of a material that given its thickness and the wavelength of the laser (for example) may be able to diminish or almost completely prevent the amount of thermal energy that is transmitted through it. In some embodiments, the blocking layer may be made of copper (Cu). Additionally, other suitable metals, alloys or ceramic materials that block, absorb, or both the laser radiation may be utilized.

FIG. 5A also shows that the laser energy, depicted by the arrows impinging upon the device is blocked by the blocking layer in the regions where it hits the blocking layer. In such embodiments, the regions designated as sensitive regions 520 would be protected from the laser energy by the blocking layer 510, but the laser energy could still function to laser anneal the peg 505. The dimensions of the fenestra 515 and configuration (in three dimensions not shown in FIG. 5A) could be chosen such that the peg 505 could still be laser annealed, but regions that were desired to be protected, sensitive regions 520 for example, would not be subjected to the energy of the laser, or not be subjected to the full energy of the laser.

FIG. 5B shows calculations of reflectance and transmittance versus the wavelength of laser energy for a 25 nm and a 60 nm thick exemplar copper blocking layer. As seen there, a 60 nm copper blocking layer (bottom most curve in FIG. 5B) will block most of the laser radiation and let less than 5% of the radiation transmit through it at wavelengths from 150 nm to 530 nm.

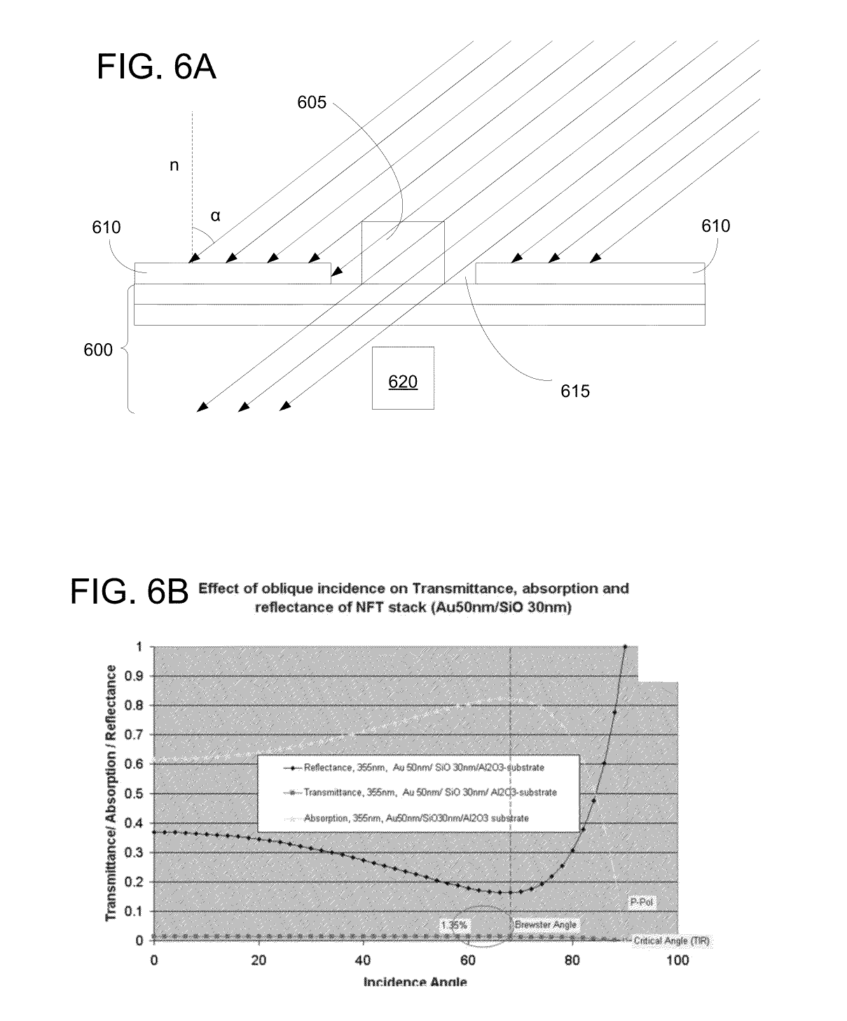

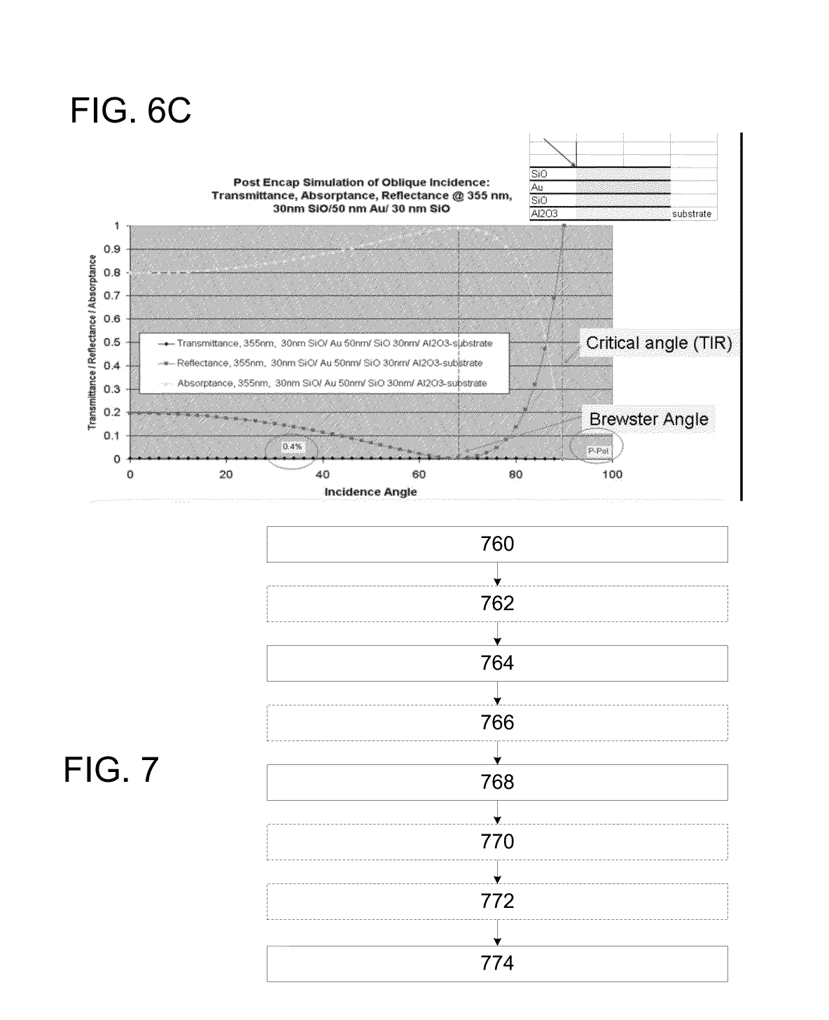

FIG. 6A shows another embodiment of a device including a blocking layer 610 over the underlying structure 600. The blocking layer 610 depicted herein again includes a fenestra 615. In this embodiment, the laser is configured to impinge upon the blocking layer 610 at an angle. This angle can be described as the angle, α, from the normal, designated by the dashed line n. This angle, α, can vary and can depend on the configuration of the fenestra and the underlying device and wafer geometry, the dimensions of the plasmonic material that is being laser annealed, or some combination thereof. In some embodiments, the angle, α, can be as high as 75° for example. In some embodiments, the angle, α, can be as high as 65° for example. In some embodiments, the angle, α, can be as low as 0°, for example. In some embodiments, the angle, α, can be as low as 15° for example. In some embodiments, the angle, α, can be around 45° for example.

Thus, a suitable oblique illumination angle can be chosen in conjunction with the blocking layer. The illumination angle with respect to the wafer surface can be chosen such that remnant laser radiation that passes through the hole or fenestrae in the blocking layer is directed harmlessly to non-critical (or non-sensitive) areas of the wafer.

FIG. 6B shows the calculated efficiency gains (better absorption) obtained as a result of oblique incidence illumination of the annealing laser radiation. There is a 20% efficiency gain going from 0° (normal incidence) to about a 63° incidence angle in this particular example. Thereby less power is required for the laser annealing, improving the thermal budget for the laser annealing process. In some embodiments, angles greater than the Brewster angle can lead to rapid fall off in absorption.

Changing the wavelength of the laser radiation can advantageously increase the absorption efficiency of the topmost NFT film or the material of the blocking layer. Thereby lesser film thickness is necessary to perform the annealing or the blocking function, thereby contributing to cost savings in the material required for the overall device. In addition, lowered material thickness of the NFT and blocker layers leads to easier integration of the process flows.

FIG. 6C shows the calculated efficiency gains (better absorption) obtained as a result of oblique incidence illumination of the annealing laser radiation in the case where the plasmonic material (e.g., the gold peg in this particular example) has been encapsulated on top by a layer of a dielectric. This optional step can be advantageous because it can prevent or diminish the post annealing surface topography of the laser annealed material cusping of the grain boundaries. Such an encapsulation may also provide mechanical rigidity of the device material during the anneal, as well as advantageously assist the NFT material to attain the desired composition. As seen from FIG. 6C, a wide incidence angle process window is evident for the encapsulated gold film.

Once the plasmonic material has been laser annealed, the blocking layer (and the optional encapsulating dielectric material) can be removed. In some embodiments, this can be accomplished by etching, for example using selective etching processes such as selective wet etching (especially, for example, in the case of a blocking layer that includes copper) or selective dry etching, or selective planarization of the blocking layer.

FIG. 7 illustrates exemplary methods that include use of a blocking layer. The method includes a first step 760, depositing a plasmonic material. The methods and materials can be such as were discussed above. Optional step 762, depositing an encapsulant, can optionally be undertaken next. The step of depositing an encapsulant can include depositing a dielectric material to protect and shape confine the plasmonic material during the laser anneal. Step 764, depositing a blocking layer, can be undertaken next. The blocking layer can include a material that blocks or absorbs the laser radiation (copper is an example of a material). The blocking layer can optionally include one more fenestra or holes therein.

In some embodiments, an optional step, step 766, a furnace anneal can be undertaken next. The optional furnace anneal, step 766, can be carried out as was discussed above._After the optional furnace anneal step 766 (or after deposition of the blocking layer step 764 if the optional furnace anneal step is not undertaken) step 768, a laser anneal step can be undertaken. The laser anneal step 768 can include steps and details such as those discussed above.

Another optional step can be undertaken next, step 770, another laser anneal. The additional laser anneal step, which can also be referred to as a secondary laser anneal step, can include steps and details such as those discussed above. Another optional step is step 772, another furnace anneal. It should be noted that either or both of the optional steps 770 and 772 can be undertaken. The additional furnace anneal step, which can also be referred to as a secondary furnace anneal step, can include steps and details such as those discussed above.

Such methods can also include step 774, removing the blocking layer. In some embodiments, step 774 can be described as selectively removing the blocking layer. Various steps including, for example etching (wet, dry, or both for example), milling, CMP, or some combination thereof can be utilized.

Exemplary methods such as those described by FIG. 7 can also include a step of removing the encapsulant for example. The methods described with respect to FIG. 7 can also optionally include the steps discussed above with respect to FIG. 1B, for example such methods can include an additional processing step (e.g., step 170 in FIG. 1B) and formation of the peg (e.g., step 172 in FIG. 1B).

In some embodiments, devices and methods such as those depicted in FIGS. 5A, 5B, 6A, 6B, 6C, and 7 can be utilized to protect any sensitive regions or structures that may be desired to be protected in the regions in the vicinity of and below the laser annealed layer. Exemplary structures can include, for example reader shields, magnetic sensors, and contact detection systems.

It should also be understood that the methods depicted herein can be utilized with other devices and structures other than NFTs for example. In some embodiments the methods could be applicable to wafer level laser annealing of any device structures, including, for example reader and writer elements.

Thus, embodiments of methods of forming near field transducers are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present disclosure is limited only by the claims that follow.

What is claimed is:

1. A method of forming a near field transducer (NFT), the method comprising:
depositing a plasmonic material; and
laser annealing the plasmonic material.

2. The method of claim 1 further comprising processing the laser annealed plasmonic material to form a NFT structure

3. The method of claim 1 further comprising depositing an antireflection layer on the plasmonic material before it is laser annealed.

4. The method of claim 1 further comprising forming a precursor NFT structure from the plasmonic material before the plasmonic material is laser annealed.

5. The method of claim 4 further comprising forming an antireflective layer over the precursor NFT structure before the plasmonic material is laser annealed.

6. The method of claim 1 further comprising forming a NFT structure from the plasmonic material before the plasmonic material is laser annealed.

7. The method of claim 6 further comprising forming an antireflective layer over the NFT structure before the plasmonic material is laser annealed.

8. The method according to claim 1 further comprising furnace annealing the plasmonic material before laser annealing.

9. The method of any according to claim 1 further comprising cleaning a surface of the plasmonic material.

10. The method of claim 1, wherein the plasmonic material has a thickness of at least about 100 nm.

11. The method of claim 1, wherein the laser annealing occurs at a wavelength of not greater than about 600 nm.

12. The method of claim 1, wherein the plasmonic material is deposited on an underlying structure and wherein the method further comprises forming a blocking layer on some portion of the underlying structure.

13. The method according to claim 12, wherein the blocking layer comprises copper.

14. The method according to claim 12, wherein the laser is directed at the blocking layer at an angle from the surface normal.

15. The method of claim 14, wherein the laser is directed at the blocking layer at an angle between about 0° and about 65° from the surface normal.

16. The method according to claim 12 further comprising depositing an encapsulsant layer on the plasmonic material before the blocking layer is formed.

17. The method according to claim 16, wherein the encapsulsant layer comprises a dielectric material.

18. A method of forming a near field transducer (NFT), the method comprising:
depositing a plasmonic material on an underlying structure;
forming a blocking layer on some portion of the underlying structure; and
laser annealing the plasmonic material, wherein the laser is directed at the blocking layer at an angle from a surface normal.

19. The method according to claim 18, wherein the laser is directed at the blocking layer at an angle between about 0° and about 65° from the surface normal.

20. A method of forming a near field transducer (NFT), the method comprising:
depositing a plasmonic material on an underlying structure;
forming an encapsulant layer on the plasmonic material, the encapsulant layer comprising a dielectric material;
forming a blocking layer on some portion of the underlying structure; and
laser annealing the plasmonic material, wherein the laser is directed at the blocking layer at an angle between about 0° and about 65° from a surface normal.
